(19) United States
(12) Patent Application Publication
(10) Pub. No.: US 2004/0142060 A1
(43) Pub. Date: Jul. 22, 2004

(54) Divided hollow core slab extruder

(75) Inventors: Joseph L. Kiss, Winnipeg (CA); Stepan Kreftsun, Winnipeg (CA)

Correspondence Address: ADE & COMPANY, 1700-360 MAIN STREET, WINNIPEG, MB, R3C3Z3, CA

(73) Assignee: Ultra-Span Technologies Inc.

(21) Appl. No.: 10/347,572

(22) Filed: Jan. 21, 2003

(51) Int. Cl. B29C 31/04; B28B 1/087

(52) U.S. Cl. 425/256; 425/380; 425/432; 249/129

(57) ABSTRACT

Hollow core concrete slabs are extruded through a compaction chamber of an extruder by a plurality of augers with forming elements at their downstream ends. A divider is supported within the compaction chamber to extrude two concrete panels at a time on opposing sides of the divider. A top plate of the compaction chamber carries vibrators on opposing sides of the divider. The top plate includes a relief formed therein in alignment with the divider to permit some independent compaction on opposing sides of the divider. The divider is fixed in relation to a frame of the extruder with a clearance gap between the divider and the top plate being provided. When extruding interlocking tongue and groove panels, the forms for the grooves are supported on opposite sides of the divider while forms for the tongues are supported on the outer sides of the compaction chamber for improved compaction of concrete at the divider.

### FIELD OF THE INVENTION

The present invention relates to improvements in the formation of hollow core slabs.

### BACKGROUND

In the formation of extruded hollow core concrete slabs, concrete may be forced into and through a compaction chamber by augers extending into the chamber. Forming elements following the augers form hollow cores in the concrete as it is forced into a slab in the compaction chamber. In order to provide a concrete product of the appropriate strength and density, the forming elements and an upper hammering plate forming the top of the compaction chamber are vibrated to plasticize and consolidate the concrete.

Known extruders are required to operate at a substantially constant width which permits only very limited adjustment due to the complex nature of the machinery driving the augers and forming elements. In certain circumstances however it is desirable to have either wider or shorter slabs to permit the slabs to be more readily handled during later construction. While it is desirable to divide the compaction chamber to form two smaller slabs in place of one larger slab, the use of a divider interferes with normal operation of conventional hammering plates resulting in concrete adjacent the divider which would be of poor quality due to lack of proper compaction because of interference from the divider.

### SUMMARY

According to the present invention there is provided an apparatus for forming extruded hollow core concrete slabs, the apparatus comprising:

a compaction chamber for forming fresh concrete into slabs;

a divider supported in the compaction chamber for forming a slab on each side of the divider;

a plurality of augers extending into the compaction chamber for delivering fresh concrete to and through the compaction chamber on each side of the divider;

a plurality of forming elements in the compaction chamber adjacent downstream ends of respective ones of the augers for forming hollow cores in the concrete slabs; and

vibrating means for vibrating one wall of the compaction chamber on each side of the divider.

The use of a divider supported within a compaction chamber permits the chamber to form two smaller slabs on opposing sides of the divider in place of one larger slab for particular applications. In particular, the use of means for vibrating the hammering plate of the compaction chamber on both sides of the divider ensures proper compaction of concrete at the divider to produce concrete slabs of high quality.

When the compaction chamber includes a common top plate forming a top side of at least part of the compaction chamber on both sides of the divider, the vibrating means are preferably supported on the common top plate.

The common top plate preferably includes a relief formed therein at the divider defining two portions of the top plate on respective opposing sides of the relief to permit some limited relative movement between the two portions of the top plate for vibrating the upper wall of the compaction chamber on both sides of the divider.

The relief is preferably formed at a trailing side of the top plate in the form of a slot which at least partly separates the top plate into the two portions. More particularly, the relief preferably comprises a through slot between top and bottom sides of the top plate which extends only partway from the trailing side to the leading side of the top plate.

When the top plate includes a liner supported thereon, the liner is preferably separated into first and second liner portions on respective opposing sides of the divider.

The vibrating means preferably includes a vibrator on each side of the divider for vibrating the common top plate.

A clearance gap between the common top plate and a top edge of the divider isolates the divider from vibration of the top plate when the divider is fixed to the frame of the apparatus.

The liner of the top plate preferably includes a relief formed therein in alignment with a top edge of the divider in the form of a gap formed between respective first and second liner portions on respective opposing sides of the divider.

The divider is preferably supported at a trailing end by a bracket having a width which is equal or less than a width of the divider and which is secured at a top end on the frame of the apparatus.

The divider may comprise an upright plate having a grout strip mounted along each side thereof which extends in a longitudinal direction of the compaction chamber for forming a groove on respective inner sides of the slabs formed on each side of the divider.

When forming concrete slabs, for example wall panels, having interlocking tongue and groove side edges, the compaction chamber preferably includes outer side walls having male forms thereon for forming a tongue extending along respective outer side edges of the slabs formed on each side of the divider. This permits the divider to include only female forms on each side thereof for forming a groove extending along respective inner side edges of the slabs formed on each side of the divider. Forming the grooves at the divider increases compaction at the divider rather than forming tongues at the divider which may lessen compaction at the divider.

When forming floor slabs, the divider preferably comprises an upright plate having opposing inner side walls which are sloped downwardly and inwardly towards one another. Accordingly, the compaction chamber includes outer side walls which are sloped downwardly and outwardly having an identical slope to that of the inner side walls.

### BRIEF DESCRIPTION OF THE DRAWINGS

In the accompanying drawings, which illustrate exemplary embodiments of the present invention:

FIG. 1 is a side elevational view of the extruder apparatus according to the present invention.

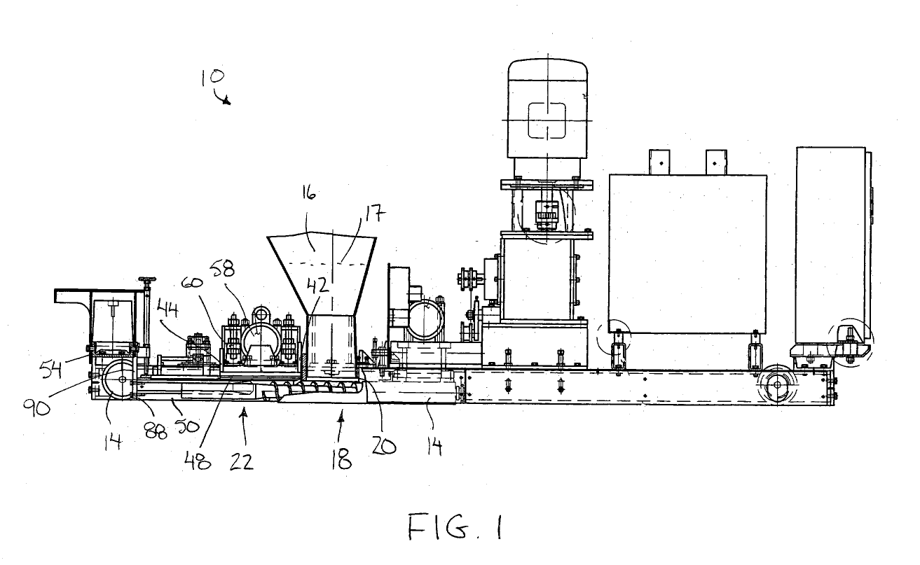

FIGS. 2 and 3 are top plan views of the extruder apparatus of FIG. 1 shown with the top plate of the compaction chamber in respective mounted end removed positions.

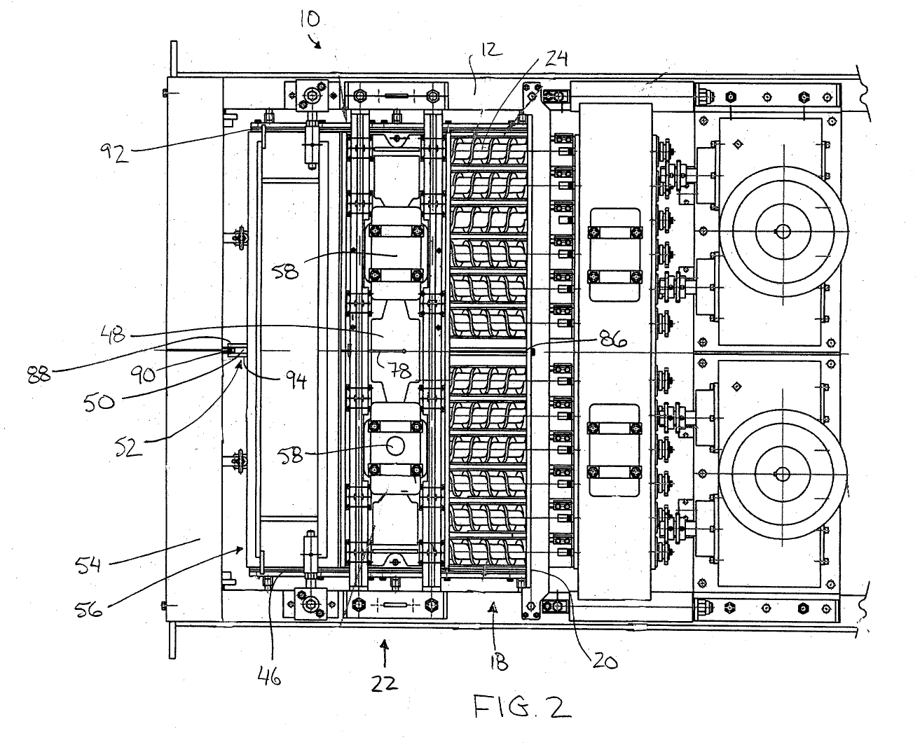

FIG. 4 is a sectional view along the line 4-4 of FIG. 2.

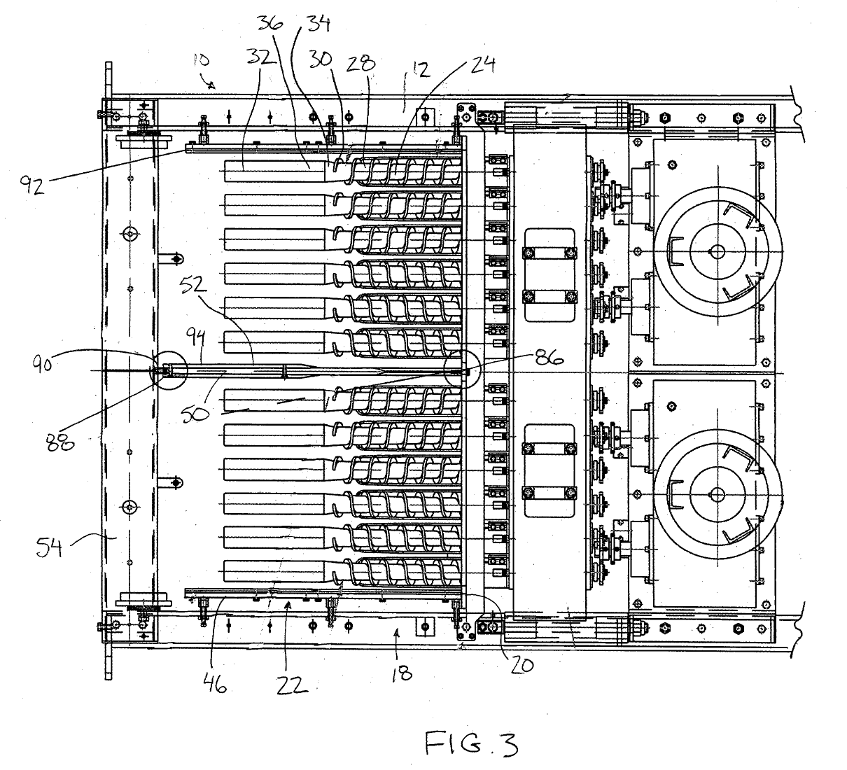

FIG. 5 is a side elevational view of the divider according to the apparatus of FIG. 1, as it is mounted on the extruder apparatus.

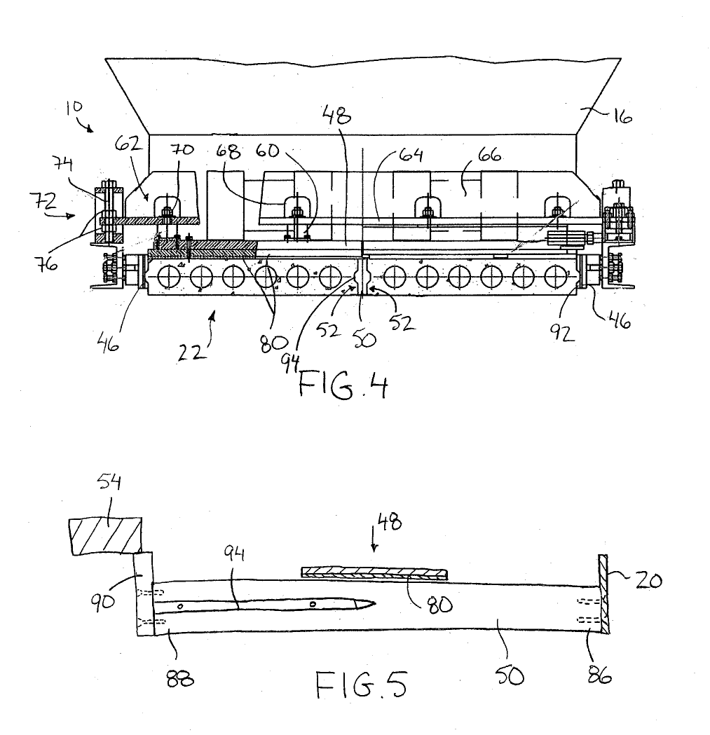

FIG. 6 is a top plan view of the top plate of the compaction chamber of the apparatus according to FIG. 1.

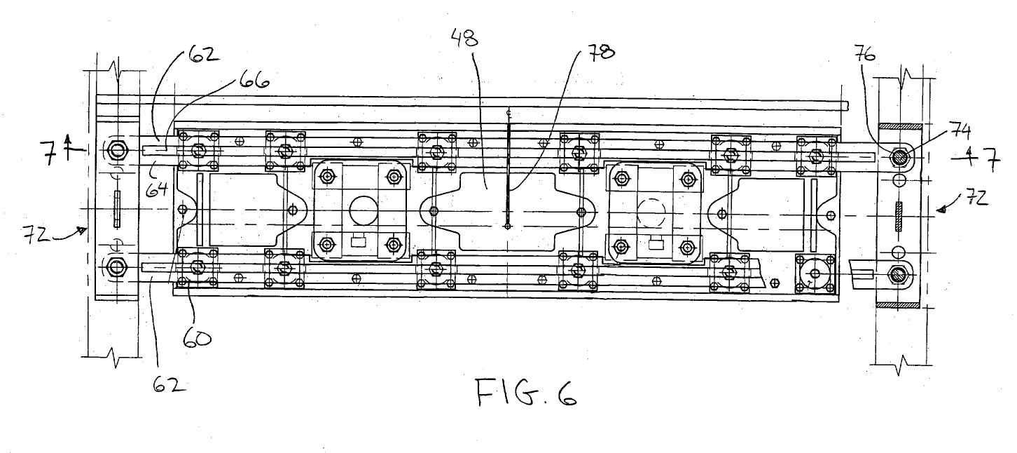

FIG. 7 is a sectional view along the line 7-7 of FIG. 6.

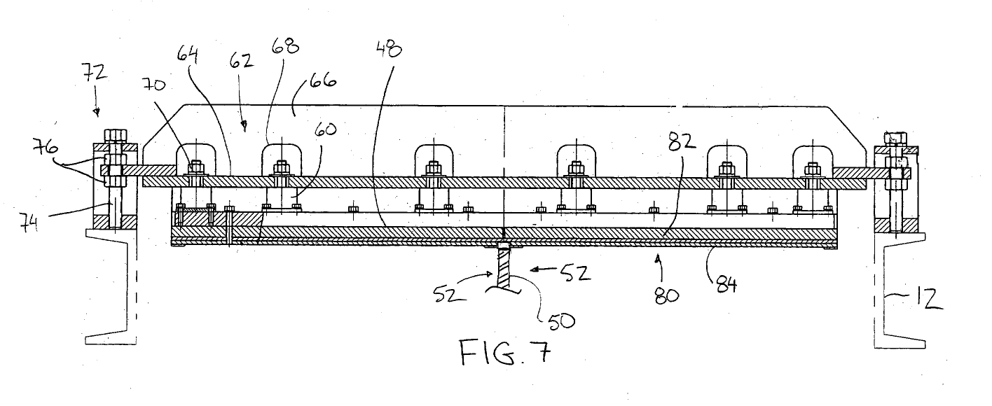

FIG. 8 is a sectional view of a further embodiment of a floor slab being formed in the extruder apparatus.

### DETAILED DESCRIPTION

Referring to the accompanying drawings, there is illustrated a concrete slab extruding apparatus generally indicated by reference numeral 10. The apparatus is supported on a frame 12 with supporting wheels 14 which are arranged for mounting on a pair of rails in the conventional manner.

The frame carries a hopper 16 which supplies fresh concrete 17 downwardly into an extruding chamber 18. The extruding chamber 18 includes a front wall plate 20 in the form of a plate enclosing the front of the extruding chamber opposite a compaction chamber 22 extending rearwardly from the extruding chamber 18. A plurality of augers 24 are supported within the extruding chamber for delivery of concrete from the hopper to the compaction chamber 22. An auger drive is provided which includes suitable gear boxes located forwardly of the front wall plate 20 for coupling to respective auger shafts extending through the front wall plate 20 to drive the augers 24 extending rearwardly from the front wall plate 20 to the compaction chamber 22.

The augers 24 each have a core 28 and helical flighting 30. The flighting has a constant diameter from end to end, concentric about the axis of rotation 32. The helical surface 34 of the core 28 spirals outwardly along the auger while remaining parallel to the axis of rotation 32. The downstream end of each auger is a forming element 36 that forms a hollow core in a slab being extruded. The forming element comprises a follower tube extending rearwardly to a free end and has a cross section which corresponds to the cross section of the hollow core being formed thereby.

The compaction chamber 22 is arranged for forming fresh concrete into slabs as the concrete is extruded therethrough by action of the augers 24 to force the concrete through the compaction chamber from the leading side 42 to the trailing side 44 positioned rearwardly therefrom. The compaction chamber includes outer side walls 46 which extend in the longitudinal direction of the compaction chamber from the leading side to the trailing side. The outer side walls 46 include respective forms thereon for forming the outer side edges of the slabs as described later herein. The compaction chamber further includes a top plate 48 which forms the top of the slabs and compacts the slabs as described in detail further below.

A divider 50 is supported within the extruding chamber and the compaction chamber for dividing the chambers into respective lefthand and righthand sides. The divider comprises a generally upright plate which extends the longitudinal direction of the compaction chamber 22 and defines a pair of inner side walls 52 on opposing sides thereof which form the respective inner side edges of the slabs being formed as described in further detail below.

The frame of the apparatus includes a cross brace 54 which is supported above the concrete slabs being extruded therebelow, downstream and rearwardly of the compaction chamber 22. A trowelling plate 56 is provided, supported on the frame, also downstream of the compaction chamber, for finishing the top surface of the slabs of concrete.

Each of the left and righthand sides of the compaction chamber includes a vibrator 58 supported on the top plate 48 of the compaction chamber. The vibrators are thus- mounted side by side at spaced positions above the top plate on respective vibrator mounting bases of the top plate. Each vibrator 58 consists of a motor with an axis of rotation and a series of eccentric weights mounted on the motor drive shaft. The weights are mounted on both ends of the motor shaft and each preferably consists of a series of metal plates that can be added and subtracted to vary the weight driving the vibrations.

The top plate 24 is mounted on a vibration isolating suspension. This includes a plurality of rubber mounts 60 arranged in two rows along opposite edges of the top plate. The plate is mounted on the bottom ends of the rubber mounts 60. The top ends of each row of mounts are connected to a respective one of two transverse suspension beams 62. Each beam is an inverted T-shape with a bottom flange 64 and an upright flange 66. Cut-outs 68 in the upright flange 66 accommodate the mounting studs and nuts 70 for the rubber mounts. The ends of the suspension beams are mounted in top plate adjustment frames 72 carried by the extruder frame 12. The adjustment frame carries a vertical bolt 74 passing through a bore in the end of the suspension beam flange 64. Two adjusting nuts 76 vary the vertical position of the suspension beam and thus the compression of the rubber mounts in, use. The rubber mounts act as a self-damping resilient suspension that isolates and concentrates the top plate movement. They limit vibration transmission to other parts of the extruder, reducing the noise generated. This also reduces the vibration energy required for compaction. The adjustability of the rubber suspension allows control of the magnitude of the top plate vibrations and results in a product that has improved dimensional accuracy.

The top plate further includes a relief 78 formed therein to extend in the longitudinal direction of the compaction chamber in alignment with the divider 50. The relief forms respective left and righthand portions in the top plate on opposing sides of the relief, and divider in alignment therewith, to permit some limited relative movement and independent vibration between the left and right portions of the top plate immediately adjacent opposing sides of the divider. The relief comprises a slot which extends through the plate from the top and bottom sides thereof only partway across the plate in the longitudinal direction of the compaction chamber. In this arrangement the top plate is only partly separated by the relief 78 for limiting the degree of independent vibration and movement between the left and right portions of the top plate. The slot forming the relief 78 extends from the trailing side of the top plate 48 approximately ¾ of the way through to the leading side so that the leading side of the top plate remains joined between the left and righthand portions thereof.

The top plate includes a top plate liner 80 in the form of low friction liner plates supported on the lower surface of the top plate. A first liner 82 spans a full width of the top plate being only divided by a seam in alignment with the divider. A second liner 84 on an outer side of the first liner 82 is provided in the form of two single plates of liner material forming respective righthand and lefthand portions of the liner 80 on opposing sides of the divider. A gap is provided between the right and lefthand portions of the second liner 84 for receiving the top edge of the divider 50. The top plate is supported so that the liner is supported within two millimetres of the top edge of the divider while still providing a gap of clearance therebetween to isolate the divider from vibrations of the top plate and liner. One vibrator 58 is supported on each of the right and lefthand portions of the top plate and liner to concentrate vibrations on opposing sides of the divider plate.

The divider 50 is supported on the apparatus in fixed relationship to the frame. A leading end 86 of the divider abuts the front wall plate 20 of the extruding chamber and is secured thereto by fasteners extending longitudinally into the divider from the opposing front side of the front wall plate. The trailing end 88 of the divider plate is secured to a bracket 90 in the form of an upright plate which abuts the trailing end 88 of the divider. Fasteners secure the bracket 90 to the trailing end of the divider by extending in the longitudinal direction of the divider from the trailing end. The bracket 90 is positioned downstream of the compaction chamber and has the same thickness as the divider 50, or a lesser thickness, so as not to interfere with extrusion of the concrete on either side of the bracket. The bracket 90 is then secured at a top end thereof above a height of the compaction chamber and the extruded concrete slabs to the rear cross brace 54 of the frame.

When forming wall panels having interlocking male and female side edges of tongue and groove configuration, the outer side walls of the compaction chamber preferably include male forms 92 supported thereon in which a groove is provided for forming the tongue extending along the male outer side edge extending along the panels or slabs being formed. The male forms 92 are supported on an adjustable side plate to position the form relative to the slabs.

Accordingly the inner side walls defined on opposing sides of the divider 50 include respective female forms 94 secured thereon for forming the corresponding grooves extending along the female inner side edges of the panels or slabs being formed. The female forms 94 generally comprise a raised rib secured to the side of the divider to extend in the longitudinal direction of the compaction chamber from a tapered leading end to a trailing end positioned rearwardly of the compaction chamber. The female forms 94 extend substantially the full length of the compaction chamber.

In this configuration with female forms 94 being formed on both sides of the divider plate and male forms being formed on the outer side walls of the compaction chamber, each slab being formed includes a respective male and female side edge for mating with like panels. The female forms 94 are located on the inner side walls of the divider as opposed to the outer side walls of the compaction chamber because the rib of the female form only acts to increase compaction rather than lessening compaction as may occur when forming the tongue of the slabs within the groove of the male forms.

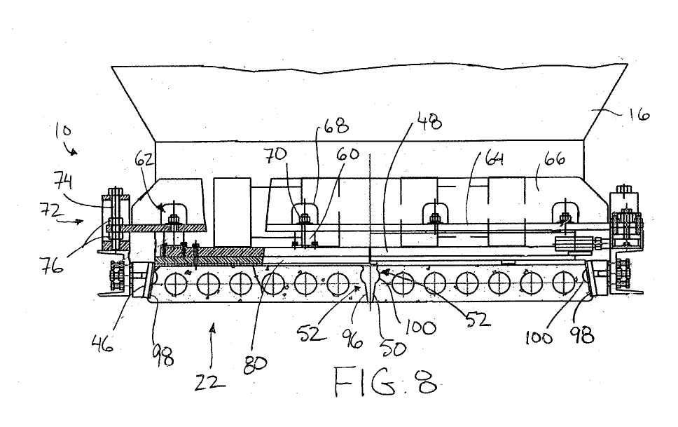

Turning now to FIG. 8 a further embodiment of the inner and outer side walls of the compaction chamber and divider are shown for forming floor slabs. In this configuration the divider 50 is shaped to have downwardly and inwardly sloping walls 96 while the outer side walls of the compaction chamber include suitable forms having downward and outward sloping walls so that each slab includes side edges which slope away from each other at approximately the same slope. The walls 96 of the divider and the forms 98 at the outer side walls of the compaction chamber further include respective grout strips 100 formed or mounted thereon to form a longitudinally extending groove along each side of the slabs being formed.

In use, the configuration of the slot 78 within the top plate enables the top plate on either side of the divider 50 to vibrate somewhat independently of the other side while limiting the independent vibrations due to the right and lefthand portions of the top plate being joined at the leading side of the plate. Providing the slot at the trailing side ensures compaction of the inner side edges of the two slabs being formed when using a divider in a common extruder chamber and compaction chamber.

When forming male and female interlocking panels or floor slabs with grout strip, female forms having a longitudinally extending rib are preferably located on the inner side walls of the divider to assist compaction rather than possibly reducing compaction using a male form for forming a tongue in the side of the concrete slab.

Providing that the divider be fixed relative to the frame of the apparatus permits the top plate to vibrate relative to the frame without interference due to the clearance being provided between the divider top edge and the top plate of the apparatus.

While some embodiments of the present invention have been described in the foregoing, it is to be understood that other embodiments are possible within the scope of the invention. The invention is to be considered limited solely by the scope of the appended claims.

1. An apparatus for forming extruded hollow core concrete slabs, the apparatus comprising:
a compaction chamber for forming fresh concrete into slabs;
a divider supported in the compaction chamber for forming a slab on each side of the divider;
a plurality of augers extending into the compaction chamber for delivering fresh concrete to and through the compaction chamber on each side of the divider;
a plurality of forming elements in the compaction chamber adjacent downstream ends of respective ones of the augers for forming hollow cores in the concrete slabs; and
vibrating means for vibrating one wall of the compaction chamber on each side of the divider.

2. The apparatus according to claim 1 wherein the compaction chamber includes a common top plate forming a top side of at least part of the compaction chamber on both sides of the divider, the vibrating means being supported on the common top plate.

3. The apparatus according to claim 2 wherein the common top plate includes a relief formed therein at the divider defining two portions of the top plate on respective opposing sides of the relief to permit some limited relative movement between the,two portions of the top plate.

4. The apparatus according to claim 3 wherein the relief is formed at a trailing side of the top plate.

5. The apparatus according to claim 3 wherein the relief comprises a slot which at least partly separates the top plate into the two portions.

6. The apparatus according to claim 3 wherein the relief comprises a through slot between top and bottom sides of the top plate which extends only partway between trailing and leading sides of the top plate.

7. The apparatus according to claim 6 wherein the slot extends inwardly from the trailing side only partway to the leading side of the top plate.

8. The apparatus according to claim 3 wherein the top plate includes a liner supported therein which is separated into first and second liner portions on respective opposing sides of the divider.

9. The apparatus according to claim 2 wherein the vibrating means includes a vibrator on each side of the divider for vibrating the common top plate.

10. The apparatus according to claim 2 wherein there is provided a clearance gap between the common top plate and a top edge of the divider.

11. The apparatus according to claim 2 wherein there is provided a liner supported on the common top plate, the liner including a relief formed therein in alignment with a top edge of the divider.

12. The apparatus according to claim 11 wherein the relief comprises a gap formed between respective first and second liner portions on respective opposing sides of the divider.

13. The apparatus according to claim 1 wherein the divider is supported in fixed relation to a frame of the apparatus.

14. The apparatus according to claim 13 wherein the divider is supported at a trailing end by a bracket having a width which is equal or less than a width of the divider and which is secured at a top end on the frame of the apparatus.

15. The apparatus according to claim 1 wherein the divider comprises an upright plate having a grout strip mounted along each side thereof which extends in a longitudinal direction of the compaction chamber for forming a groove on respective inner sides of the slabs formed on each side of the divider.

16. The apparatus according to claim 1 for forming concrete slabs having interlocking tongue and groove side edges, the compaction chamber including side walls having male forms thereon for forming a tongue extending along respective outer side edges of the slabs formed on each side of the divider and the divider including female forms on each side thereof for forming a groove extending along respective inner side edges of the slabs formed on each side of the divider.

17. The apparatus according to claim 1 wherein the divider comprises an upright plate having opposing inner side walls which are sloped downwardly and inwardly and the compaction chamber includes outer side walls which are sloped downwardly and outwardly.
